(19) United States
(12) Patent Application Publication
(10) Pub. No.: US 2015/0278952 A1
(43) Pub. Date: Oct. 1, 2015

(54) LEVERAGING SPEND BEHAVIOR TO CREATE EQUITY PORTFOLIOS

(71) Applicant: MASTERCARD INTERNATIONAL INCORPORATED, Purchase, NY (US)

(72) Inventors: Jean Pierre Gerard, Croton-on-Hudson, NY (US); Po Hu, Norwalk, CT (US)

(73) Assignee: MASTERCARD INTERNATIONAL INCORPORATED, Purchase, NY (US)

(21) Appl. No.: 14/224,677

(22) Filed: Mar. 25, 2014

(51) Int. Cl. G06Q 40/06

(52) U.S. Cl. CPC G06Q 40/06

(57) ABSTRACT

A method and/or system is provided that includes retrieving from one or more databases a first set of information with the first set of information having payment card transaction sales data associated with each of a plurality of merchants; and retrieving from one or more data bases a second set of information with the second set of information having securities market data associated with each of the plurality of merchants. The method further includes generating one or more groupings of merchants based on the first set of information and the second set of information; ranking each of the merchants, relative to the other merchants, in the one or more groupings into a hierarchy based on selection criteria; identifying a predetermined number of merchants ranked at different levels of the hierarchy in the one or more groupings; selecting the identified merchants from the one or more groupings; and combining the selected merchants into an index.

### BACKGROUND OF THE DISCLOSURE

1. Field of the Disclosure

The present disclosure relates to a method and a system for leveraging payment card holder spend behavior to create equity portfolios. In particular, payment card holder spend behavior information can be leveraged in a way so as to generate an index on which investment products (e.g., index mutual funds, exchange traded funds, index portfolios, index futures, and options) can be based.

2. Description of the Related Art

An index is generally a list of securities (e.g., stocks, bonds, and/or commodities) or companies within a securities market. Typically, an index functions as a statistical measure of change in a securities market. An index also can track the ups and downs of the securities market by reflecting market prices and the number of shares outstanding for the companies in the index. Some investment products can be created based on indexes. Examples of investment products include exchange traded funds, index funds, and mutual funds.

Most commonly used stock market indices are constructed using a methodology that is based upon either the relative share prices of a sample of companies (such as the Dow Jones Industrial Average) or the relative market capitalization of a sample of companies (such as the S&P 500 Index or the FTSE 100 Index). The nature of the construction of both of these types of indices means that if the price or the market capitalization of one company rises relative to its peers it is accorded a larger weighting in the index. Alternatively, a company whose share price or market capitalization declines relative to the other companies in the index is accorded a smaller index weighting. This can create a situation where the index, index funds, or investors who desire their funds to closely track an index, are compelled to have a higher weighting in companies whose share prices or market capitalizations have already risen and a lower weighting in companies that have seen a decline in their share price or market capitalization.

Price or market capitalization based indices can contribute to a herding behavior on the behalf of investors by effectively compelling any of the funds that attempt to follow these indices to have a higher weighting in shares as their price goes up and a lower weighting in shares that have declined in price. This creates unnecessary volatility, which is not in the interests of most investors. It may also lead to investment returns that absorb the phenomenon of having to repeatedly increase weightings in shares after the shares have risen, and reducing weightings in shares after the shares have fallen.

Capitalization-weighted indexes (“cap-weighted indexes”) dominate the investment industry today. Unfortunately, cap-weighted indexes suffer from an inherent flaw since these indexes overweight all overvalued stocks and underweight all undervalued stocks. This causes cap-weighted indexes to under-perform relative to indexes that are immune to this shortcoming. In addition, cap-weighted indexes are vulnerable to speculative bubbles and emotional bear markets that may unnaturally drive up or down stock prices, respectively.

Equal-weighted indexation is a popular alternative to cap-weighting but one that suffers from its own shortcomings. One significant problem with equal-weighted indexes is that they come out of the same cap-weighted universes as cap-weighted indexes. For example, the S&P Equal Weighted Index simply re-weights the 500 equities that comprise the S&P 500, retaining the bias already inherent to cap-weighted indexes.

High turnover and associated high costs are additional problems of equal-weighted indexes. Equal-weighted indexes include small illiquid stocks, which are required to be held in equal proportion to the larger, more liquid stocks in the index. These small illiquid stocks must be traded as often as the larger stocks but at a higher cost because they are less liquid.

What is needed is an alternate method of weighting that is based upon metrics other than share price weighting, market capitalization or equal weighting, and overcomes the shortcomings of these conventional methods.

### SUMMARY OF THE DISCLOSURE

The present disclosure provides an index that comprises a plurality of merchants (i.e., merchant securities) with each merchant associated with a payment card company and ranked relative to the other merchants based on a selection criteria. The selection criteria comprises (i) payment card transaction sales gross dollar volume (GDV) at each of the plurality of merchants for a defined time period and/or (ii) number of payment card transaction sales at each of the plurality of merchants for a defined time period.

The present disclosure also provides a method that comprises retrieving from one or more databases a first set of information with the first set of information comprising payment card transaction sales data associated with each of a plurality of merchants; and retrieving from one or more data bases a second set of information with the second set of information comprising securities market data associated with each of the plurality of merchants. The method further comprises generating one or more groupings of merchants based on the first set of information and the second set of information; ranking each of the merchants, relative to the other merchants, in the one or more groupings into a hierarchy based on selection criteria; identifying a predetermined number of merchants ranked at different levels of the hierarchy in the one or more groupings; selecting the identified merchants from the one or more groupings; and combining the selected merchants into an index.

The selection criteria used in the method of this disclosure also comprises (i) payment card transaction sales gross dollar volume (GDV) at each of the plurality of merchants for a defined time period and/or (ii) number of payment card transaction sales at each of the plurality of merchants for a defined time period.

The present disclosure further provides a system that includes one or more databases configured to store a first set of information with the first set of information comprising payment card transaction sales data associated with each of a plurality of merchants; and one or more data bases configured to store a second set of information with the second set of information comprising securities market data associated with each of the plurality of merchants. The system also includes a processor configured to: generate one or more groupings of merchants based on the first set of information and the second set of information; rank each of the merchants, relative to the other merchants, in the one or more groupings into a hierarchy based on selection criteria; identify a predetermined number of merchants ranked at different levels of the hierarchy in the one or more groupings; select the identified merchants from the one or more groupings; and combine the selected merchants into an index.

The present disclosure yet further provides an index which includes a plurality of merchants (i.e., merchant securities). Each merchant is associated with a payment card company. Each merchant is ranked relative to the other merchants of the plurality of merchants based on the selection criteria.

The present disclosure leverages payment card holder spend behavior information in a way that generates an index that is useful for a variety of applications. In one embodiment, payment card holder spend behavior information can be leveraged in a way that generates an index on which investment products (e.g., index mutual funds, exchange traded funds, index portfolios, index futures, and options) can be based. In another embodiment, payment card holder spend behavior information can be leveraged in a way that is broad based and is representative of one or more business sectors on a macroscale. Such information can be useful, for example, in competitive surveillance, identifying business trends, and the like.

### BRIEF DESCRIPTION OF THE DRAWINGS

FIG. 1 is a schematic diagram of a four party payment card system.

FIG. 2 is a schematic representation of methods and systems for compiling and dividing assets of merchant groups according to one embodiment of the present disclosure.

FIG. 3 is a schematic diagram illustrating an exemplary composition of an index according to one example embodiment of the present disclosure.

FIG. 4 is an operational flow for a creation process for creating an index according to one example embodiment of the present disclosure.

FIG. 5 is an operational flow for a creation process for creating an index according to one example embodiment of the present disclosure.

FIG. 6 illustrates a first arrangement of information stored within a database in accordance with one example embodiment of the present disclosure.

FIG. 7 illustrates a second arrangement of information stored within the database of FIG. 6 in accordance with one example embodiment of the present disclosure.

FIG. 8 illustrates a third arrangement of information stored within the database of FIG. 6 in accordance with one example embodiment of the present disclosure.

FIG. 9 illustrates a fourth arrangement of information stored within the database of FIG. 6 in accordance with one example embodiment of the present disclosure.

FIG. 10 illustrates the composition of an index formed using the creation process of FIG. 5.

FIG. 11 is an operational flow for a process for creating an investment product in accordance with one example embodiment of the present disclosure.

FIG. 12 is a schematic representation of a computing system that may be used to implement aspects of the present disclosure.

A component or a feature that is common to more than one drawing is indicated with the same reference number in each of the drawings.

### DETAILED DESCRIPTION OF THE PREFERRED EMBODIMENTS

Embodiments of the present disclosure are now described more fully hereinafter with reference to the accompanying drawings, in which some, but not all, embodiments of the disclosure are shown. Indeed, the present disclosure can be embodied in many different forms and should not be construed as limited to the embodiments set forth herein. Rather, these embodiments are provided so that this disclosure clearly satisfies applicable legal requirements. Further, like numbers herein refer to like elements throughout.

As used herein, merchants can include one or more businesses, companies, corporations, persons, organizations, institutions and/or other entities, such as retail stores, services providers, and the like that implement one or more portions of one or more of the embodiments described and/or contemplated herein. In an embodiment, the merchants are publicly traded companies listed on a public exchange such as a stock exchange. In another embodiment, the merchants are not publicly traded companies and are not listed on a public exchange such as a stock exchange. Also, as used herein, merchants can include merchant securities in the appropriate context.

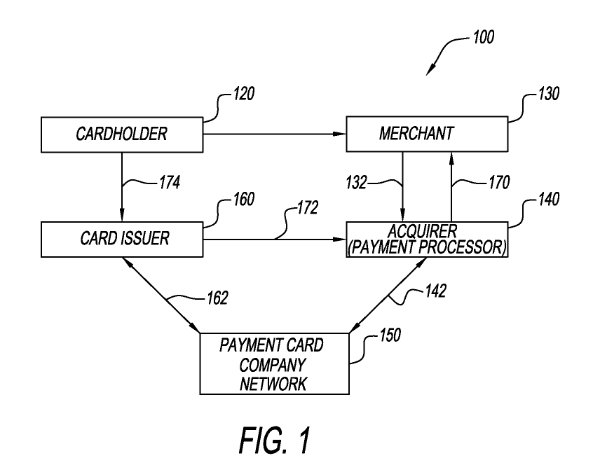

As used herein, a payment card company can include one or more financial transaction processing entities or other entities that are part of the payment card company network 150 in FIG. 1. Illustrative payment card companies include, for example, MasterCard®, VISA®, American Express®, and the like.

As used herein, “social media” refers to any type of electronically-stored information that users send or make available to other users for the purpose of interacting with other users in a social context. Such media can include directed messages, status messages, broadcast messages, audio files, image files and video files. Reference in this disclosure to “social media websites” should be understood to refer to any website that facilitates the exchange of social media between users. Examples of such websites include social networking websites such as FACEBOOK and LINKEDIN, and microblogging websites such as TWITTER. Social media also refers to newspapers and magazines.

As used herein, the one or more databases configured to store the first set of information or from which the first set of information is retrieved, the one or more databases configured to store the second set of information or from which the second set of information is retrieved, the one or more databases configured to store the third set of information or from which the third set of information is retrieved, and the one or more databases configured to store the fourth set of information or from which the fourth set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Pert, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

In an embodiment, the method of this disclosure involves retrieving from one or more databases a first set of information, the first set of information comprising payment card transaction sales data associated with each of a plurality of merchants; and retrieving from one or more data bases a second set of information, the second set of information comprising securities market data associated with each of the plurality of merchants. The method further involves generating one or more groupings of merchants based on the first set of information and the second set of information; ranking each of the merchants, relative to the other merchants, in the one or more groupings into a hierarchy based on selection criteria; identifying a predetermined number of merchants ranked at different levels of the hierarchy in the one or more groupings; selecting the identified merchants from the one or more groupings; and combining the selected merchants into an index.

The method of this disclosure further involves rebalancing the index on a periodic basis, based on payment card transaction sales (GDV). The index can be rebalanced, for example, on a yearly, quarterly, half year, or multiple year basis. Preferably, the index is rebalanced, based on payment card transaction sales (GDV), when a threshold value is exceeded.

The sorting, ranking, identifying, selecting and combining included in the method of this disclosure involves the use one or more algorithms. Also, the rebalancing included in the method of this disclosure uses one or more algorithms.

In another embodiment, the system of this disclosure generally includes one or more databases configured to store a first set of information with the first set of information comprising payment card transaction sales data associated with each of a plurality of merchants; and one or more data bases configured to store a second set of information with the second set of information comprising securities market data associated with each of the plurality of merchants. The system also includes a processor configured to: generate one or more groupings of merchants based on the first set of information and the second set of information; rank each of the merchants, relative to the other merchants, in the one or more groupings into a hierarchy based on selection criteria; identify a predetermined number of merchants ranked at different levels of the hierarchy in the one or more groupings; select the identified merchants from the one or more groupings; and combine the selected merchants into an index.

The processor is further configured to rebalance the index on a periodic basis, based on payment card transaction sales (GDV). Preferably, the processor is further configured to rebalance the index on a yearly, quarterly, half year, or multiple year basis. More preferably, the processor is further configured to rebalance the index when a threshold value is exceeded.

The processor is configured to sort, rank, identify, select and combine using one or more algorithms. Also, the processor is configured to rebalance using one or more algorithms.

Embodiments of the present disclosure can leverage payment card holder spend behavior information in a way that generates an index on which investment products (e.g., index mutual funds, exchange traded funds, index portfolios, index futures, and options) can be based. Alternatively, the present disclosure can leverage payment card holder spend behavior information in a way that generates an index that is broad based and is representative of one or more business sectors on a macroscale. Such information can be useful, for example, in competitive surveillance, identifying business trends, and the like.

The index of this disclosure comprises a plurality of merchants (i.e., merchant securities). Each merchant is associated with a payment card company. Each merchant is also ranked relative to the other merchants based on selection criteria. The selection criteria comprise (i) payment card transaction sales gross dollar volume (GDV) at each of the plurality of merchants for a defined time period and/or (ii) number of payment card transaction sales at each of the plurality of merchants for a defined time period.

The payment card transaction sales (GDV) of each of the plurality of merchants for a defined period, and/or the number of payment card transaction sales at each of the plurality of merchants for a defined time period, are algorithmically analyzed to generate or rebalance an index. For example, relative weightings of the merchants that comprise the index can be generated or rebalanced when the weighting of one or more of the merchants exceeds 20%, preferably 25%, of the size of the index, based on merchant payment card transaction sales (GDV) for a defined time period.

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the card holder completes the purchase and receives a receipt.

The account of the merchant 130 is credited, via 170, by the acquirer 140. The card issuer 160 pays, via 172, the acquirer 140. Eventually, the cardholder 120 pays, via 174, the card issuer 160.

An index formed according to an embodiment of the present disclosure includes a plurality of merchants that are associated with a payment card company (e.g., part of the payment card company network 150 in FIG. 1). The merchants are ranked relative to the other merchants based on selection criteria. The selection criteria comprise (i) payment card transaction sales gross dollar volume (GDV) at each of the plurality of merchants for a defined time period and/or (ii) number of payment card transaction sales at each of the plurality of merchants for a defined time period.

An example method of selecting the merchants according to an embodiment of the present disclosure includes obtaining payment card transaction sales data associated with each of a plurality of merchants, and securities market data associated with each of the plurality of merchants and generating one or more groupings of merchants based on the payment card transaction sales data and the securities market data. Further, each merchant is ranked, relative to the other merchants, in the one or more groupings into a hierarchy based on selection criteria (e.g., payment card transaction sales gross dollar volume (GDV) at each of the plurality of merchants for a defined time period), and a predetermined number of merchants ranked at different levels of the hierarchy in the one or more groupings are identified. Then, the identified merchants from the one or more groupings are selected and the selected merchants combined into an index.

In accordance with an embodiment, the method includes obtaining a listing of merchants associated with a payment card company, and filtering the listing to include only merchants having payment card transaction sales gross dollar volume (GDV) greater than, less than, or equal to a certain threshold level over a defined time period.

In an example embodiment, the index is created by populating a database with identities of merchants associated with a payment card company, and desired information about each company (e.g., payment card transaction sales gross dollar volume (GDV) for a defined time period). Creating the index also includes analyzing the information in the database to organize and rank the merchants based on the desired information. A predetermined number of merchants are selected and combined to form the index.

Examples of selection criteria include payment card transaction sales gross dollar volume (GDV) for a defined time period greater than, less than, or equal to a certain threshold level, number of payment card transaction sales for a defined time period greater than, less than, or equal to a certain threshold level, and the like.

In general, the present disclosure includes an index on which investment products (e.g., index mutual funds, exchange traded funds, index portfolios, index futures, and options) can be based. Preferably, the index lists components reflecting the top companies or corporations associated with a payment card company. The top companies associated with a payment card company are chosen according to a set of selection criteria. The selection criteria includes (i) payment card transaction sales (GDV) at each of the plurality of merchants for a defined time period and/or (ii) number of payment card transaction sales at each of the plurality of merchants for a defined time period.

An index formed according to the principles of this disclosure can include securities from one or more select merchant companies. Each merchant company is associated with a payment card company (e.g., part of the payment card company network 150 in FIG. 1).

In other example embodiments, the index includes merchant companies that are associated with a payment card holder and that meet selection criteria. For example, in an embodiment, the index includes ten (10) merchants associated with payment card companies having a particular payment card transaction sales gross dollar volume (GDV) for a defined period.

A method of forming the index according to an embodiment of the present disclosure generally includes obtaining a listing of merchants associated with a payment card company. Merchants can be chosen for inclusion in the index based on selection criteria. Some non-limiting examples of selection criteria include payment card transaction sales gross dollar volume (GDV) for a defined period, number of payment card transaction sales for a defined time period, and the like. Other optional selection criteria include, for example, total market capitalization, price-to-earnings ratio, total dividends paid out, and total earnings generated. Merchants associated with a payment card company are chosen based on the selection criteria. These merchants are combined as components in the index.

The method can also include excluding merchants based on predetermined eligibility criteria. Merchants can be excluded from the index if eligibility requirements are not met. For example, some non-limiting examples of excluding merchants from the index include the merchant having payment card transaction sales (GDV) more than or less than a certain threshold level over a defined time period.

Generally, the index is managed by regularly adding merchants to and deleting merchants from the index to conform to periodic changes in the identity of the select merchants. For example, when a constituent within the index is no longer one of the top companies associated with a payment card company based on the selection criteria, then the constituent can be deleted. Typically, a new constituent having payment card transaction sales (GDV) greater than or less than a certain threshold level over a defined time period is substituted for the deleted constituent. In addition, companies involved in mergers, acquisitions, or significant restructuring, thereby affecting their association with the payment card company, that result in a drop in rank based on the selection criteria can be deleted and/or replaced.

In general, the amount by which each component affects the index is determined by the weight of each component. In one embodiment, the index is calculated based on payment card transaction sales (GDV). Relative weightings of the merchants that comprise the index are rebalanced when the weighting of one or more of the merchants exceeds 20%, preferably 25%, of the size of the index, based on merchant payment card transaction sales (GDV) for a defined time period. Also, for example, relative weightings of the merchants that comprise the index are rebalanced when the total payment card transaction sales (GDV) of the index increases or decreases in size by at least 20%, preferably at least 25%.

The index can be rebalanced periodically to alter the weight factor applied to each component of the index, if necessary. For example, the weight factor for each component may need to be changed to reflect a lack of eligible companies having payment card transaction sales (GDV) greater than or less than a certain threshold level over a defined time period. In different embodiments, the index can be rebalanced quarterly, annually, monthly, daily, or at any desired time.

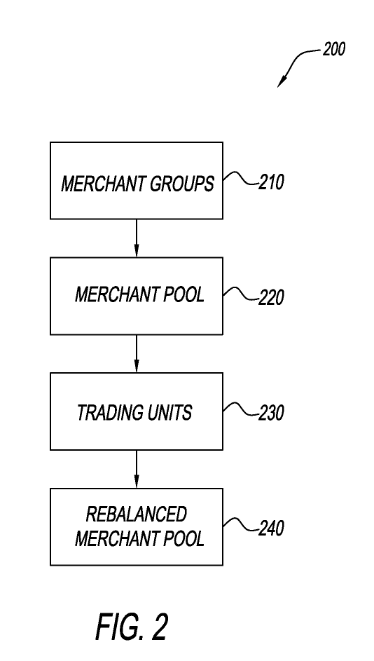

FIG. 2 illustrates a schematic representation of methods and systems 200 for trading a portion of assets from merchant pool 220 and rebalancing, based on payment card transaction sales (GDV), a merchant pool 220 arranged according to an index. The components of the merchant groups 210 can be equally weighted within the indexed merchant pool 220. In other embodiments, components of a first merchant group 210 can be weighted differently than components of a second merchant group 210. In still other embodiments, the components of a single merchant group 210 can be weighted differently.

The assets from merchant pool 220 are then divided into trading units 230. In some example embodiments, the trading units 230 represent equal, undivided ownership interests in the assets of merchant pool 220. Generally, each trading unit 230 can be bought and sold individually or in groups. In some embodiments, the trading units 230 can be bought and sold via a public exchange such as a stock exchange.

In general, the assets included in a merchant group 210 share common properties. In some embodiments, the assets of merchant groups 210 can include a listing of select securities meeting predetermined selection criteria. For example, in an embodiment, all assets in a first merchant group 210 can include securities of merchants having payment card transaction sales (GDV) greater than a certain threshold level over a defined time period. In another example embodiment, all assets in merchant group 210 can include securities of merchants having payment card transaction sales (GDV) less than a certain threshold level over a defined time period. In other embodiments, the groups of assets of merchants 210 can include indexes, portfolios, and other such groupings of assets.

The merchant pool 220 can be rebalanced, based on merchant payment card transaction sales (GDV), into merchant pool 240. In some example embodiments, the components of rebalanced merchant pool 240 can be equally weighted or weighted differently.

In some example embodiments, all of the rebalanced merchants 240 include substantially the same payment card transaction sales (GDV) in substantially the same proportions. In some other embodiments, two or more groups of rebalanced merchants 240 are formed from the merchant pool 220 using filter criteria, each group having similar payment card transaction sales (GDV) in similar proportions.

Alternatively, as described herein, the present disclosure leverages spend behavior information (e.g., merchant payment card transaction sales (GDV) information) in a way that generates an index, not based on investment products, that is broad based and is representative of one or more business sectors on a macroscale. Such information can be useful, for example, in competitive surveillance, identifying business trends, and the like.

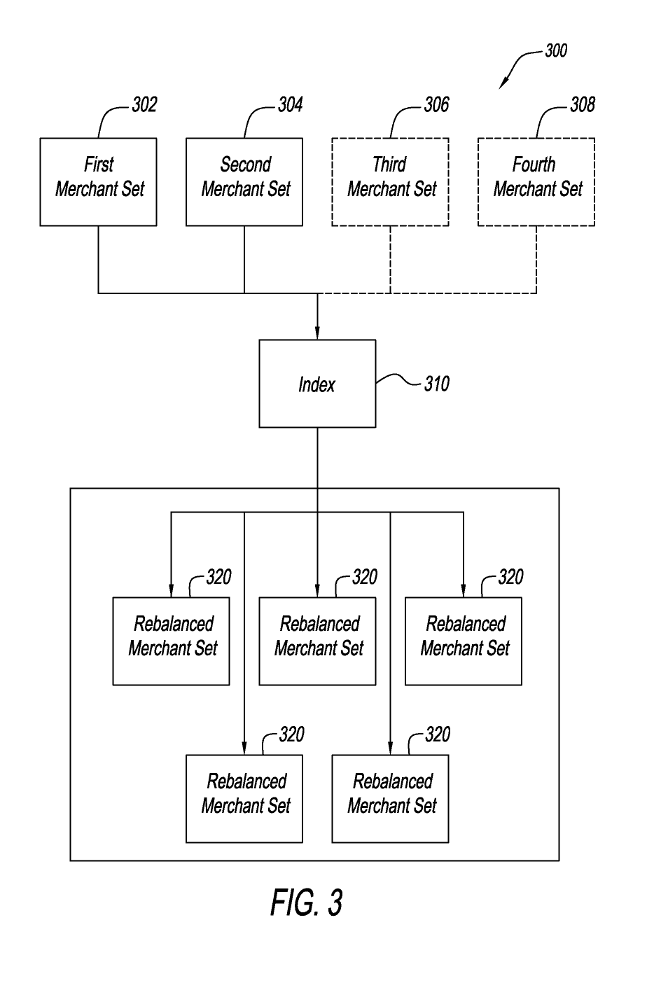

Referring now to FIG. 3, the present disclosure relates to an investment information system 300 having features that are examples of principles of the present disclosure. The investment information system 300 includes at least the assets of two merchant groups 302, 304 forming constituents of an index 310 from which an investment product can be formed. The index 310 can be composed of multiple merchant groups. In the example embodiment shown in FIG. 3, the index lists four merchant groups 302, 304, 306, 308. The index can also be composed of rebalanced merchant groups. In the example embodiment shown in FIG. 3, the index lists multiple rebalanced merchant groups 320.

In some example embodiments, the index 310 is formed from at least two assets of merchant groups 302, 304. In one example embodiment, the index 310 is composed of securities selected to represent the relative strength of merchants having payment card transaction sales (GDV) above a certain threshold level over a defined time period. Each asset of merchant group 302, 304 represents assets of merchants having payment card transaction sales (GDV) at a certain threshold level over a defined time period. Of course, the index 310 also can be formed based on any number of underlying assets of merchant groups or underlying indexes.

In one example embodiment, preferably, the investment system 300 includes an investment product that provides investors with the opportunity to purchase a security representing a proportionate, undivided interest in a portfolio of securities designed to generally correspond to the net price and yield performance of the underlying index 310. Individual securities of merchant groups can be listed to trade on a security exchange (e.g., a stock exchange) at prices established throughout the trading day, similar to any other equity security trading in the secondary market on an exchange.

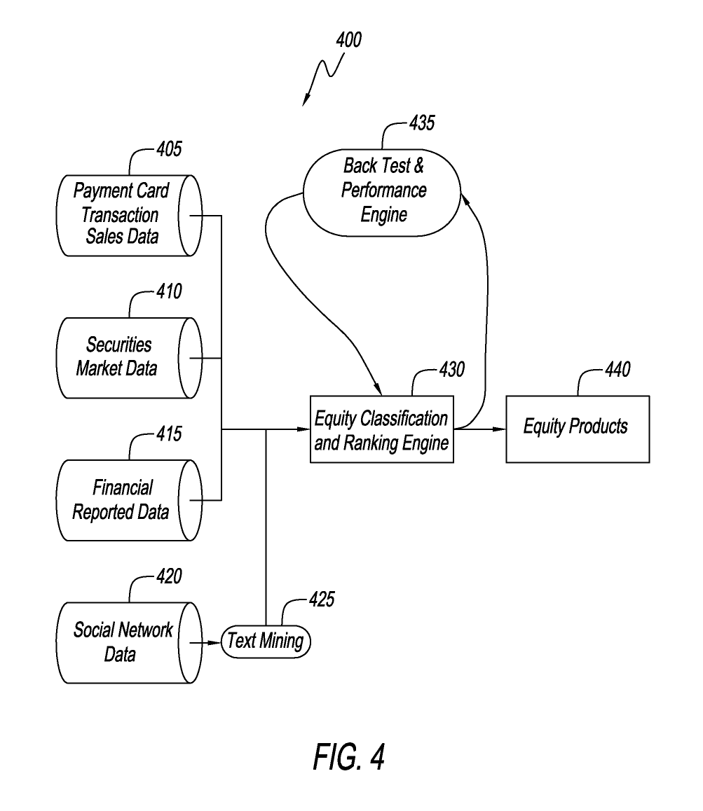

FIG. 4 illustrates an operational flow for a creation process 400 for creating an index according to one example embodiment of the present disclosure. The process 400 involves retrieving from one or more databases 405 a first set of information with the first set of information comprising payment card transaction sales data associated with each of a plurality of merchants; retrieving from one or more data bases 410 a second set of information with the second set of information comprising securities market data associated with each of the plurality of merchants; retrieving from one or more data bases 415 a third set of information with the third set of information comprising financial reported data associated with each of the plurality of merchants; and retrieving from one or more databases 420 a fourth set of information with the fourth set of information comprising social media information indicative of consumer sentiment of a merchant for a defined time period. The social media information is mined at 425 and the mined social media information is used in ranking the merchants as discussed herein.

Illustrative payment card transaction sales data includes, for example, payment card transaction sales gross dollar volume (GDV) for a defined time period, number of payment card transaction sales for a defined time period, geolocation of payment card transaction sales, and the like.

Illustrative securities market data includes, for example, current and historical merchant stock price data, earnings per share, price-to-earnings ratio, price-to-earnings growth ratio, price-to-sales ratio, price-to-cash flow ratio, price-to-book value ratio, beta, short interest ratio, dividend yield, and the like.

The price-to-earnings ratio is an indicator of what the market is paying for a company's earnings at any given moment. The price-to-earnings ratio is a company's price-per-share divided by its earnings-per-share. The price-to-earnings growth ratio is calculated by dividing the price-to-earnings ratio by the projected earnings growth rate. The price-to-sales ratio is the company's price divided by its sales (or revenue). The price-to-cash flow ratio is the company's price divided by its cash flow.

Book value is a company's assets minus its liabilities. The book value is what would be left over for shareholders if the company was sold and its debt retired. The price-to-book value ratio measures what the market is paying for those net assets (also known as shareholder equity). Beta is the calculation used to quantify that volatility. The beta figure compares the stock's volatility to that of the S&P 500 index using the returns over the past five years. The short-interest ratio is an indicator of how many days, given the stock's average trading volume, it would take short sellers to cover their positions (i.e., buy stock) if good news sent the price higher and mined their negative bets. A dividend is a payment many companies make to shareholders out of their excess earnings. It is usually expressed as a per-share amount. When comparing a company's dividends, however, “dividend yield” or simply the “yield” is used. That is the dividend amount divided by the stock price. It is an indicator of what percentage of an investor's purchase price the company will return to the investor in dividends.

The securities market data is useful in more fully understanding the merchant, selecting and/or weighting the merchant in the index, or contributing to the overall formation of the index.

Illustrative merchant financial reported data includes, for example, information from a Form 10-Q quarterly report, a Form 10-K annual report, or other publicly reported sales data. Other illustrative merchant information can include, for example, information that provides a formal record of the financial activities and a snapshot of a merchant's financial health. Financial statements typically include four basic financial statements, accompanied by a management discussion and analysis. The Balance Sheet reports on a company's assets, liabilities, and ownership equity at a given point in time. The Income Statement reports on a company's income, expenses, and profits over a period of time. Profit & Loss account provide information on the operation of the enterprise. These include sale and the various expenses incurred during the processing state. The Statement of Retained Earnings explains the changes in a company's retained earnings over the reporting period. The Statement of Cash Flows reports on a company's cash flow activities, particularly its operating, investing and financing activities.

While merchant payment card transaction sales (GDV) over a defined time period and securities market data are of primary concern for enabling formation of an index, the additional merchant financial information described above can also be useful in more fully understanding the merchant, selecting and/or weighting the merchant in the index, or contributing to the overall formation of the index.

The fourth set of information includes social media information indicative of consumer sentiment of a merchant for a defined time period. The fourth set of information is retrieved from, for example, TWITTER, FACEBOOK, FOURSQUARE, GOOGLE+, YELP, AMAZON. COM customer reviews, FOURSQUARE, PINTEREST, PATCH.COM, ANGIESLIST.COM, EPINIONS.COM, newspapers, and/or magazines.

Social media data that records consumer communications is used to quantify consumer sentiment of a merchant. The spontaneous nature of the social media data provides better insights into true consumer sentiment of a merchant.

Social media data and other data that reflects consumer sentiment of a merchant are used to quantify the consumer sentiment at both an aggregate and micro level. Using the social media data, the system can reveal micro-granularity in consumer sentiment that is typically smoothed out in quantification results obtained via a survey approach (e.g., based on aggregating responses from questionnaires and polls).

Consumer sentiment of a merchant is established via evaluating consumer sentiment information derived from one or more different social media data sources, such as social network feeds, news feeds, and the like. Such social media data sources are analyzed to quantify consumer sentiment, and to identify trending of quantified consumer sentiment based on the current social media data. The consumer sentiment of the merchant can be designated as positive, negative or neutral.

Illustrative merchant sentiment information includes, for example, the degree to which merchant positive sentiment and merchant overall sentiment are correlated for a defined time period, the degree to which industry positive sentiment and industry overall sentiment are correlated for a defined time period, and the degree to which merchant positive sentiment and industry positive sentiment are correlated for the defined time period. Information involving merchant negative sentiment and industry negative sentiment are also part of this disclosure.

The process 400 further involves generating at 430 one or more groupings of merchants based on the first set of information, the second set of information, the third set of information and the fourth set of information. Illustrative sectors and categories into which the merchants can be grouped include, for example, a sector, a market, a market sector, an industry sector, a geographic sector, an international sector, a sub-industry sector, a government issue, and/or a tax exempt financial object. In particular, the groupings, sectors and categories can include one or more of the following:

### Agriculture, Forestry, Fishing and Hunting

### Mining

### Utilities

### Construction

### Manufacturing

### Wholesale Trade

### Retail Trade

### Transportation and Warehousing

### Information

### Finance and Insurance

### Real Estate and Rental and Leasing

### Professional, Scientific, and Technical Services

### Management of Companies and Enterprises

### Administrative and Support and Waste Management and Remediation Services

### Education Services

### Health Care and Social Assistance

### Arts, Entertainment, and Recreation

### Accommodation and Food Services

### Other Services

### Public Administration

Each merchant is ranked at 430, relative to the other merchants, in the one or more groupings into a hierarchy based on selection criteria. As stated previously, the selection criteria includes (i) payment card transaction sales gross dollar volume (GDV) at each of the plurality of merchants for a defined time period and/or (ii) number of payment card transaction sales at each of the plurality of merchants for a defined time period.

At 430, a predetermined number of merchants ranked at different levels of the hierarchy in the one or more groupings are identified. At 435, back testing eliminates merchants from the list(s) based on eligibility criteria or rebalancing. For example, in an embodiment, merchants (i.e., merchant securities) having payment card transaction sales (GDV) less than a certain threshold level over a defined time period may be removed from the list(s). The identified merchants from the one or more groupings are selected, and the selected merchants combined into an index at 440.

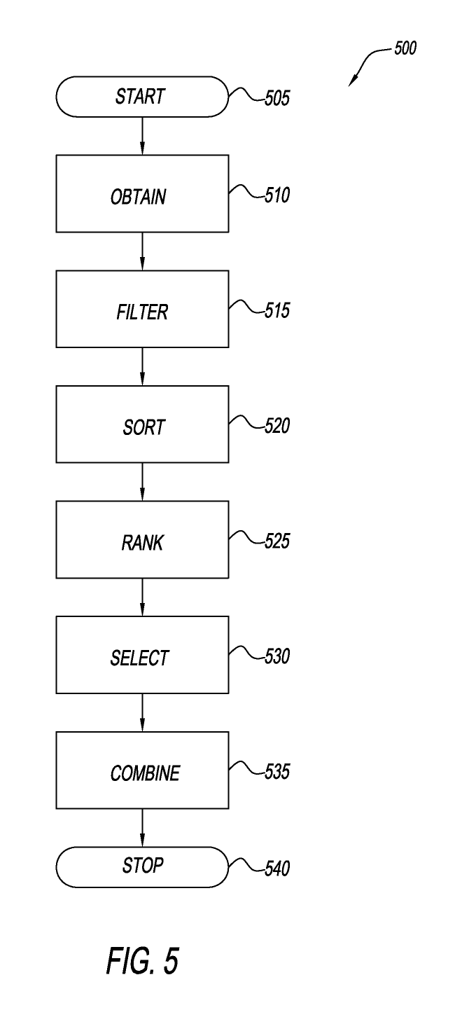

FIG. 5 illustrates an operation flow chart depicting an example creation process 500 for producing a merchant payment card transaction sales (GDV) based index, such as the index 310 shown in FIG. 3. The creation process 500 initializes and commences at a start module 505 and proceeds to an obtain operation 510.

The obtain operation 510 acquires, from one or more databases, one or more lists of merchants (i.e., merchant securities) from which select merchants (i.e., merchant securities) will be chosen for inclusion in the index. Each security is associated with a merchant, and each merchant is associated with a payment card company (e.g., part of the payment card company network 150 in FIG. 1). Typically, each merchant is associated with only one type of security (e.g., a specific class of stocks). If a company is associated with multiple types of securities, then one of the securities can be chosen and represented in the list.

In an example embodiment, the obtain operation 510 obtains a list of merchants (i.e., merchant securities) associated with payment card companies. In another embodiment, the obtain operation 510 acquires a list of merchants (i.e., merchant securities) having payment card transaction sales (GDV) at a certain threshold level over a defined time period.

The creation process 500 analyzes and processes the list(s) of merchants (i.e., merchant securities) acquired in the obtain operation 510 in subsequent operations, such as filter 515, sort 520, and rank 525. While an example sequence for these operations is provided in FIG. 5, the disclosure is not so limited and these subsequent operations filter 515, sort 520, rank 525 can be performed in any desired order.

Filter operation 515 eliminates merchants from the list(s) based on eligibility criteria. For example, in an embodiment, merchants (i.e., merchant securities) having payment card transaction sales (GDV) less than a certain threshold level over a defined time period may be removed from the list(s).

Sort operation 520 divides the merchants (i.e., merchant securities) based on payment card transaction sales (GDV) for a defined period of time. For example, in an embodiment, the merchants (i.e., merchant securities) having payment card transaction sales (GDV) greater than a certain threshold level over a defined time period can be divided from merchants (i.e., merchant securities) having payment card transaction sales (GDV) less than a certain threshold level over a defined time period. In an example embodiment, the sort operation 520 divides the merchants (i.e., merchant securities) into lists based on business sectors or categories.

Rank operation 525 applies predetermined selection criteria to the merchants (i.e., merchant securities) to rank the merchants (i.e., merchant securities) in a hierarchy. For example, in an embodiment, the rank operation 525 ranks the companies by total payment card transaction sales (GDV) from largest to smallest. In other embodiments, the rank operation 525 ranks the companies based on market capitalization. Optional ranking criteria include revenue, earnings, profit margin, earnings per share, sales, dividends, date a company incorporated, and the like.

A select or selection operation 530 determines the top merchants (i.e., merchant securities) of each sorted list and a combine operation 535 forms the index with the selected merchants (i.e., merchant securities). For example, in an embodiment, the selection operation 530 determines the top ten merchants (i.e., merchant securities) within each sorted list based on the selection criteria. The combine operation 535 creates an index having these top ten merchants (i.e., merchant securities) having payment card transaction sales (GDV) as components. The creation process 500 completes and ends at a stop module 540.

In different embodiments, the selection operation 530 and combine operation 535 can utilize a different number of merchants (i.e., merchant securities). For example, in an embodiment, the select operation 530 can determine the top two merchants (i.e., merchant securities) having specified payment card transaction sales (GDV). In another embodiment, the select operation 530 can determine the top fifty merchants (i.e., merchant securities) having specified payment card transaction sales (GDV). In yet another embodiment, the select operation 530 can determine the top one-hundred (100) merchants (i.e., merchant securities) having specified payment card transaction sales (GDV).

In an example embodiment, the combine operation 535 assigns the same weighting to each constituent in the index. For example, in an index formed by combining the ten largest companies by payment card transaction sales (GDV), each constituent of the index would have a weighting of 0.20. The weight can be rebalanced periodically to keep the weight substantially equal. In another example embodiment, if the index described above does not include 500 constituents due to lack of eligible companies, then the weighting is adjusted accordingly when rebalancing the index.

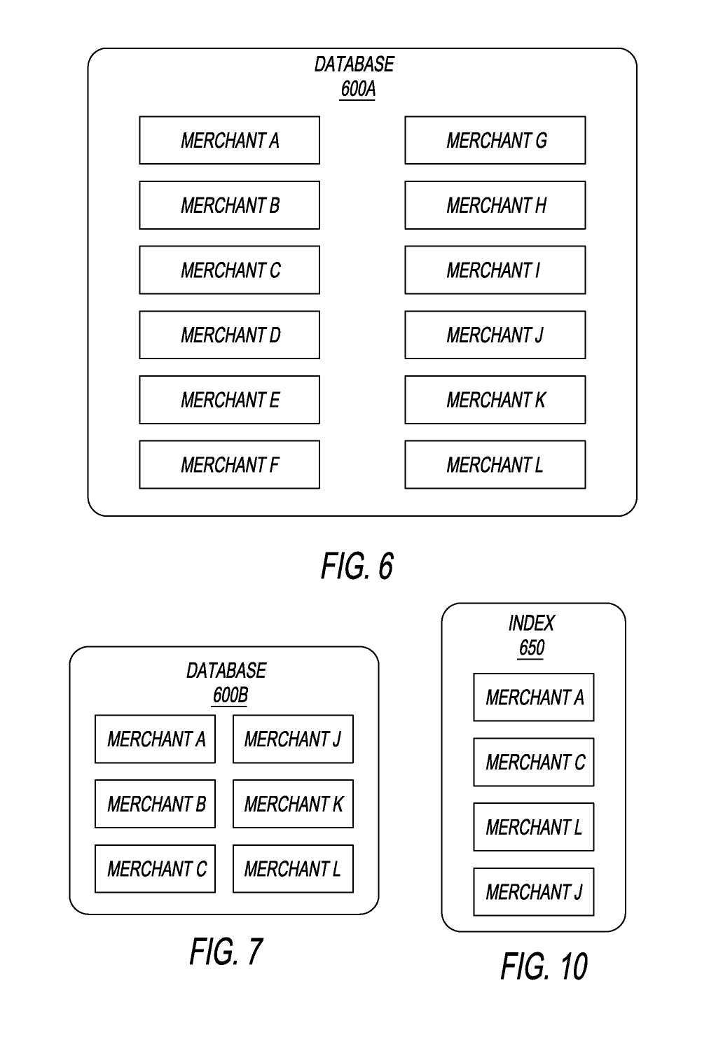

Referring to FIGS. 6-9, the teachings of the present disclosure can best be understood through the description of an example application. In an example embodiment, an index is created by populating a database with identities of companies, and information about each company (e.g., payment card transaction sales (GDV) over a defined time period) related to selection criteria.

This information can be manipulated using the operations of creation process 500 shown in FIG. 5. FIGS. 6-9 illustrate changes in the arrangement of information stored within a database 600. FIG. 6 shows the results from performing the obtain operation 510 of FIG. 5 in accordance with an embodiment of the disclosure. In particular, FIG. 6 shows the database 600A containing a list of merchants or merchant companies A-L having securities and payment card transaction sales (GDV) over a defined time period. Information pertaining to each merchant A-L is not expressly shown (e.g., payment card transaction sales (GDV) over a defined time period), but will be understood to be included.

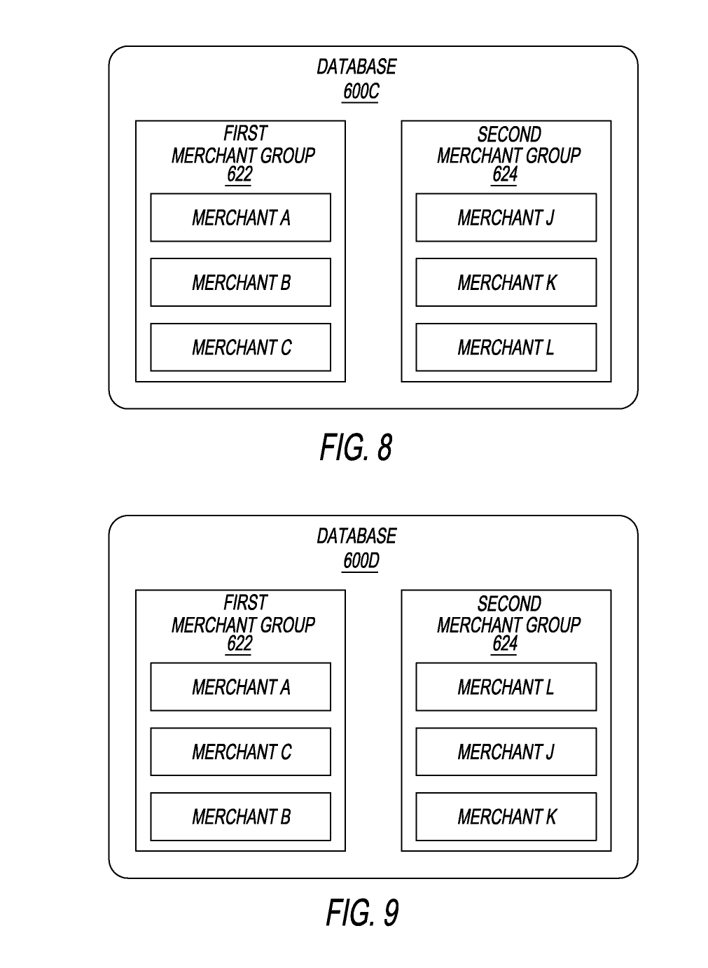

The results of the filter operation 515 are shown in FIG. 7. In the embodiment shown, merchants (i.e., merchant securities) D-I did not meet the eligibility requirements and so have been eliminated from the listing stored in database 600B. The sort operation 520 results in the database arrangement 600C shown in FIG. 8. The merchants (i.e., merchant securities) in database 600C shown in FIG. 8 have been arranged into lists 622, 624 by payment card transaction sales (GDV) over a defined time period. In the example shown, companies A-C have payment card transaction sales (GDV) at a certain threshold level over a defined time period, and companies J-L have payment card transaction sales (GDV) at a different threshold level over a defined time period.

The results of the rank operation 525 are shown in database arrangement 600D of FIG. 9. The database arrangement 600D includes the first list 622 of merchants (i.e., merchant securities) having payment card transaction sales (GDV) at a certain threshold level over a defined time period, and the second list 624 of merchants (i.e., merchant securities) having payment card transaction sales (GDV) at a different threshold level over a defined time period. The companies of each list 622, 624 have been ranked according to selection criteria (e.g., payment card transaction sales (GDV) over a defined time period).

For example, the companies can have been ranked according to total payment card transaction sales (GDV) over a defined time period. In the example shown, company A has a larger amount of payment card transaction sales (GDV) than company C, which has a larger amount of payment card transaction sales (GDV) than company B. Company L has a larger amount of payment card transaction sales (GDV) than company J, which has a larger amount of payment card transaction sales (GDV) than company K. Of course, other selection criteria can also be used.

A predetermined number of ranked companies are selected and combined to form the index. FIG. 10 shows the index 650 resulting from execution of the select operation 530 and the combine operation 535 in accordance with an embodiment of the disclosure. In the example shown, the index 650 includes a combination of the top two companies A, C, L, and J selected from each sorted list 622, 624.

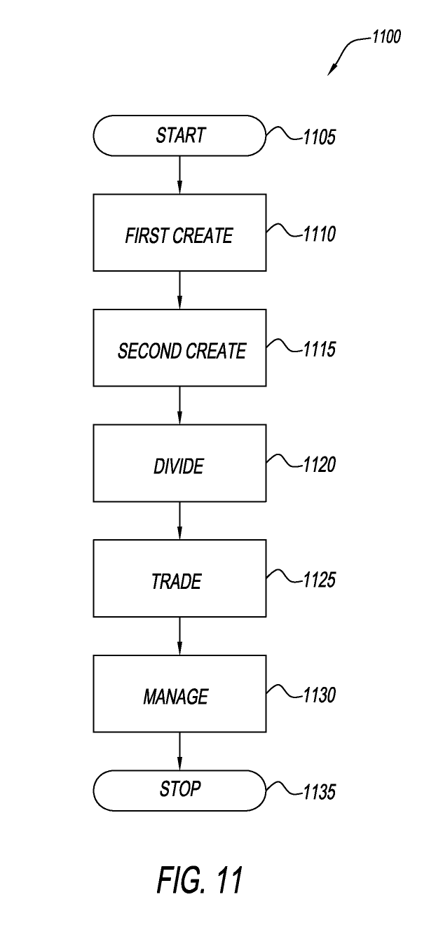

FIG. 11 illustrates an operation flow chart depicting an example process 1100 for creating and trading an investment product on a security exchange. The process 1100 begins at operation 1105 and proceeds to first create operation 1110. The first create operation 1110 forms an underlying index on which the investment product will be based. In an example embodiment, the first create operation 1110 forms the index using the creation process 500 from FIG. 5.

A second create operation 1115 produces an investment product based on the index. For example, the second create operation 1115 can create an exchange traded fund based on the index. The exchange traded fund is a security that includes multiple stocks, similar to a mutual fund, but trades on a stock market exchange like an ordinary stock. In an embodiment, the exchange traded fund is formed by obtaining securities from each company listed in the index.

A divide operation 1120 divides the investment product into tradable units (e.g., shares). Each share represents an undivided ownership interest in the investment product. A trade or exchange operation 1125 trades the shares of the investment product on a security exchange. For example, shares of an exchange traded fund can be bought and sold on a security exchange, such as the New York Stock Exchange, AMEX, the NASDAQ, the national market, and the NASDAQ small cap.

A manage operation 1130 manages the index. For example, the manage operation 1030 can delete, add, and/or substitute companies in the index due to changes in eligibility and/or rank. Preferably, merchants are added to and deleted from the index on a non-discretionary, automatic basis when external events occur. Component weighting of the index can also be determined and adjusted on a non-discretionary basis. In an example embodiment, the manage operation 1130 determines whether changes should be made to the composition as needed and rebalances, based on merchant payment card transaction sales (GDV), the weighting of the index. As described herein, the index can be rebalanced periodically to alter the weight factor applied to each component of the index, if necessary. In different embodiments, the index can be rebalanced quarterly, annually, monthly, daily, or at any desired time. The process ends at 1135.

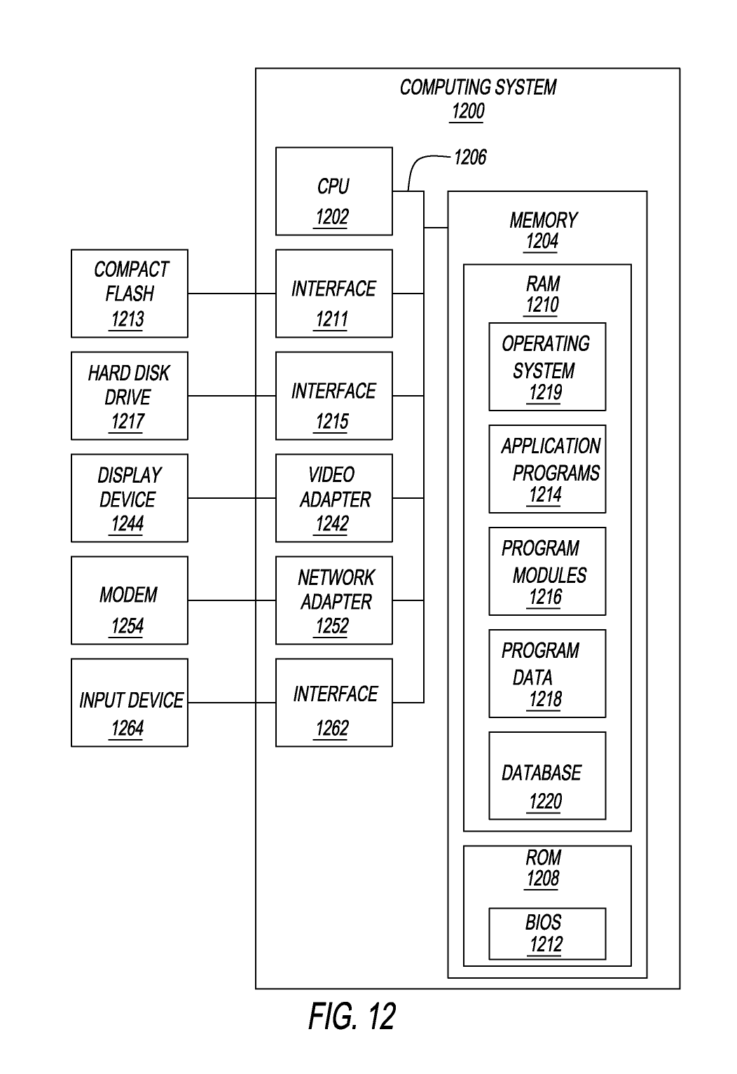

Referring to FIG. 12, an exemplary environment for implementing embodiments of the present disclosure includes a general purpose computing device in the form of a computing system 1200, including at least one processing unit (e.g., a CPU) 1202. Different types of processing units 1202 are available from a variety of manufacturers, for example, Intel® or Advanced Micro Devices®.

The computing system 1200 includes a system memory 1204, and a system bus 1206 that couples the system components including the system memory 1204 to the processing unit 1202. The system bus 1206 might be any of several types of bus structures including a memory bus or memory controller; a peripheral bus; and a local bus using any of a variety of bus architectures. Preferably, the system memory 1204 includes read only memory (ROM) 1208 and random access memory (RAM) 1210. A basic input/output system 1212 (BIOS) containing the basic routines that help transfer information between components within the computing system 1200, such as during start-up, is typically stored in the ROM 1208.

Preferably, the computing system 1200 further includes a secondary storage device 1217, such as a hard disk drive, for reading from and writing to a hard disk (not shown), and/or a compact flash card 1213. The hard disk drive 1217 and compact flash card 1213 are connected to the system bus 1206 by a hard disk drive interface 1215 and a compact flash card interface 1211, respectively. The drives and cards and their associated computer-readable media provide nonvolatile storage of computer readable instructions, data structures, program modules and other data for the computing system 1200.

Although the exemplary environment described herein employs a hard disk drive 1217 and a compact flash card 1213, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules can be stored on the hard disk 1217, compact flash card 1213, ROM 1208, or RAM 1210. Examples of such program modules include an operating system 1219, one or more application programs 1214, other program modules 1216, and program data 1218. Databases 1220 can also be stored on the memory 1204 and external media.

A user can enter commands and information into the computing system 1200 through an input device 1264. Examples of input devices include a keyboard, mouse, microphone, joystick, game pad, satellite dish, scanner, digital camera, touch screen, and a telephone. These and other input devices are often connected to the processing unit 1202 through an interface 1262 that is coupled to the system bus 1206. These input devices can also be connected by any number of interfaces, such as a parallel port, serial port, game port, or a universal serial bus (USB).

A display device 1244, such as a monitor or touch screen LCD panel, is also connected to the system bus 1206 via an interface, such as a video adapter 1242. The display device 1244 can be internal or external. In addition to the display device 1244, computing systems, in general, typically include other peripheral devices (not shown), such as speakers, printers, and palm devices.

When used in a LAN networking environment, the computing system 1200 is connected to the local network through a network interface or adapter 1252. When used in a WAN networking environment, such as the Internet, the computing system 1200 typically includes a modem 1254 or other means, such as a direct connection, for establishing communications over the wide area network. The modem 1254, which can be internal or external, is connected to the system bus 1206 via the interface 1252. In a networked environment, program modules depicted relative to the computing system 1200, or portions thereof, can be stored in a remote memory storage device. It will be appreciated that the network connections shown are exemplary and other means of establishing a communications link between the computing systems may be used.

A computing device, such as computing system 1200, typically includes at least some form of computer-readable media. Computer readable media can be any available media that can be accessed by the computing system 1200. By way of example, and not limitation, computer-readable media can comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 1100.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer-readable media. Computer-readable media is also referred to as computer program product.

It will be understood that the present disclosure can be embodied in a computer readable non-transitory storage medium storing instructions of a computer program which when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is stated herein that something is “based on” something else, it can be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving from one or more databases a first set of information, the first set of information comprising payment card transaction sales data associated with each of a plurality of merchants;
retrieving from one or more data bases a second set of information, the second set of information comprising securities market data associated with each of the plurality of merchants;
generating one or more groupings of merchants based on the first set of information and the second set of information;
ranking each of the merchants, relative to the other merchants, in the one or more groupings into a hierarchy based on selection criteria;
identifying a predetermined number of merchants ranked at different levels of the hierarchy in the one or more groupings;
selecting the identified merchants from the one or more groupings; and
combining the selected merchants into an index.

2. The method of claim 1, wherein the one or more groupings is one or more units selected from the group consisting of a sector, a market, a market sector, an industry sector, a geographic sector, an international sector, a government issue sector, and a tax-exempt sector.

3. The method of claim 1, wherein the one or more groupings is one or more sectors selected from the group consisting of a construction industry sector; manufacturing industry sector; wholesale trade industry sector; retail trade industry sector; transportation or warehousing industry sector; information industry sector; finance or insurance industry sector; real estate or rental or leasing industry sector; professional, scientific, or technical services industry sector; management of companies or enterprises industry sector; administrative or support or waste management or remediation services industry sector; education services industry sector; health care or social assistance industry sector; arts, entertainment, or recreation industry sector; accommodation or food services industry sector; agriculture, forestry, fishing or hunting industry sector; mining industry sector; utilities industry sector; other services industry sector; and public administration industry sector.

4. The method of claim 1, wherein the selection criteria comprises (i) payment card transaction sales gross dollar volume (GDV) at each of the plurality of merchants for a defined time period and/or (ii) number of payment card transaction sales at each of the plurality of merchants for a defined time period.

5. The method of claim 1, further comprising:
retrieving from one or more data bases a third set of information, the third set of information comprising financial reported data associated with each of the plurality of merchants; and
generating the one or more groupings of merchants based on the first set of information, the second set of information, and the third set of information.

6. The method of claim 5, further comprising:
retrieving from one or more databases a fourth set of information, the fourth set of information comprising social media information indicative of consumer sentiment of a merchant for a defined time period; and
generating the one or more groupings of merchants based on the first set of information, the second set of information, the third set of information, and the fourth set of information.

7. The method of claim 1, further comprising rebalancing the index on a periodic basis.

8. The method of claim 1, wherein the retrieving, generating, ranking, identifying, selecting and combining steps use one or more algorithms.

9. The method of claim 1, wherein the relative ranking of each of the merchants in the one or more groupings provides relative weightings of the merchants that comprise the index, and are rebalanced when the weighting of one or more of the merchants exceeds 25% of the size of the index, based on merchant payment card transaction sales (GDV) for a defined time period.

10. The method of claim 1, wherein the relative ranking of each of the merchants in the one or more groupings is from largest to smallest, based on merchant payment card transaction sales (GDV) for a defined time period.

11. A system comprising:
one or more databases configured to store a first set of information, the first set of information comprising payment card transaction sales data associated with each of a plurality of merchants;
one or more data bases configured to store a second set of information, the second set of information comprising securities market data associated with each of the plurality of merchants;
a processor configured to:
generate one or more groupings of merchants based on the first set of information and the second set of information;
rank each of the merchants, relative to the other merchants, in the one or more groupings into a hierarchy based on selection criteria;
identify a predetermined number of merchants ranked at different levels of the hierarchy in the one or more groupings;
select the identified merchants from the one or more groupings; and
combine the selected merchants into an index.

12. The system of claim 11, wherein the one or more groupings is one or more units selected from the group consisting of a sector, a market, a market sector, an industry sector, a geographic sector, an international sector, a government issue sector, and a tax-exempt sector.

13. The system of claim 11, wherein the one or more groupings is one or more sectors selected from the group consisting of a construction industry sector; manufacturing industry sector; wholesale trade industry sector; retail trade industry sector; transportation or warehousing industry sector; information industry sector; finance or insurance industry sector; real estate or rental or leasing industry sector; professional, scientific, or technical services industry sector; management of companies or enterprises industry sector; administrative or support or waste management or remediation services industry sector; education services industry sector; health care or social assistance industry sector; arts, entertainment, or recreation industry sector; accommodation or food services industry sector; agriculture, forestry, fishing or hunting industry sector; mining industry sector; utilities industry sector; other services industry sector; and public administration industry sector.

14. The system of claim 11, wherein the selection criteria comprises (i) payment card transaction sales gross dollar volume (GDV) at each of the plurality of merchants for a defined time period and/or (ii) number of payment card transaction sales at each of the plurality of merchants for a defined time period.

15. The system of claim 11, further comprising:
one or more data bases configured to store a third set of information, the third set of information comprising financial reported data associated with each of the plurality of merchants; and
a processor configured to:
generate the one or more groupings of merchants based on the first set of information, the second set of information, and the third set of information.

16. The system of claim 15, further comprising:
one or more databases configured to store a fourth set of information, the fourth set of information comprising social media information indicative of consumer sentiment of a merchant for a defined time period; and
a processor configured to:
generate the one or more groupings of merchants based on the first set of information, the second set of information, the third set of information, and the fourth set of information.

17. The system of claim 11, further comprising a processor configured to rebalance the index on a periodic basis.

18. The system of claim 11, wherein the processor is configured to retrieve, generate, rank, identify, select and combine use one or more algorithms.

19. The system of claim 11, wherein the relative ranking of each of the merchants provides relative weightings of the merchants that comprise the index, and are rebalanced when the weighting of one or more of the merchants exceeds 25% of the size of the index, based on merchant payment card transaction sales (GDV).

20. An index comprising:
a plurality of merchants, wherein:
each merchant is associated with a payment card company;
each merchant is ranked relative to the other merchants of the plurality of merchants based on selection criteria; and
wherein the selection criteria comprises (i) payment card transaction sales gross dollar volume (GDV) at each of the plurality of merchants for a defined time period and/or (ii) number of payment card transaction sales at each of the plurality of merchants for a defined time period.

21. The index of claim 20, wherein the index is rebalanced, based on merchant payment card transaction sales (GDV), by at least one computer processor when a threshold value is exceeded.
